(19) United States
(12) Patent Application Publication
(10) Pub. No.: US 2003/0050127 A1
(43) Pub. Date: Mar. 13, 2003

(54) Method and apparatus for balancing driveshafts

(76) Inventors: Mark S. Barrett, Orion, MI (US); Karthik Sivakumar, Rochester Hills, MI (US); Marc M. Menosky, Burt, MI (US)

Correspondence Address: HARNESS, DICKEY & PIERCE, P.L.C., P.O. BOX 828, BLOOMFIELD HILLS, MI, 48303, US

(21) Appl. No.: 09/951,205

(22) Filed: Sep. 13, 2001

(51) Int. Cl. F16C 3/00

(52) U.S. Cl. 464/180

(57) ABSTRACT

A driveshaft assembly has a tubular element with yokes coupled at the ends of the tubular element. The yoke includes a stub shaft portion for inserting into and welding the yoke to the tubular element. A receiving portion is present in the yoke to receive a universal joint. A balancing portion is present on the yoke to balance the rotational imbalance of the driveshaft. The balancing portion includes a desired mass of material so that in order to rotationally balance the driveshaft, mass may be removed from the balancing portion of the yoke.

### FIELD AND BACKGROUND OF THE INVENTION

The present invention relates to driveshafts and, more particularly, to a method and an apparatus for balancing the rotational imbalance of a driveshaft.

Balancing of automotive drivelines is critical to provide optimum performance of the automotive vehicle. Ordinarily, a driveshaft for the driveline is formed by a roll formed tube which includes yokes welded at each end. The yokes receive universal joints to be connected with other components. The tube, although manufactured to tight tolerances, will not be uniformly cylindrical, in cross-section, or absolutely straight throughout its length. The tube will have irregularity in its wall thickness. Similarly, irregularities appear in the cast or forged yokes which are connected to the tube. The material in geometrical variations will provide an incongruent mass and rotational centers causing eccentric loading imbalance. This may lead to vibration and vehicle noise which will be amplified by the constant whipping of the unbalanced weight distribution of the driveline.

In order to balance the steel driveshafts and yoke, ordinarily a small weight is welded to the steel tubes or preferably to the end of the tubes adjacent the overlap of the yokes. Also, adhesive metallic tape had been utilized in an attempt to balance driveshafts. Further, riveted pads, which pierce the wall of the drive tubes, have been used. Disadvantages of the above is that the adhesive bond may become contaminated and fail. Also, the piercing of the tube creates an unsealed tube which violates automotive requirements. Thus, welding balancing weights onto the tube is the predominant technique.

With the advent of aluminum or aluminum base driveshafts, the welding of material cannot be used since the steel weights do not weld or braise to the aluminum material. Less dense weights, such as aluminum weights, which would weld to the aluminum, are used. However, the size and mass of proper distribution of weight made their use difficult. Thus, using the dissimilar metals on an aluminum driveshaft assembly remains a difficult process.

### SUMMARY OF THE INVENTION

The present invention overcomes the drawbacks of the prior art. The present invention provides an assembly where, instead of adding material, material is removed to balance the driveshaft. The yokes include a portion which enables removal of material or mass to balance the rotational imbalance.

From the following detailed description, taken in conjunction with the drawings and subjoined claims, other objects and advantages of the present invention will become apparent to those skilled in the art.

### BRIEF DESCRIPTION OF THE DRAWINGS

FIG. 1 is a schematic view of a driveline of a vehicle including a driveshaft in accordance with the present invention.

FIG. 2 is a plan view of a driveline assembly in accordance with the present invention.

FIG. 3 is an enlarged partial section view of an end of the driveshaft of FIG. 2.

### DETAILED DESCRIPTION OF THE PREFERRED EMBODIMENTS

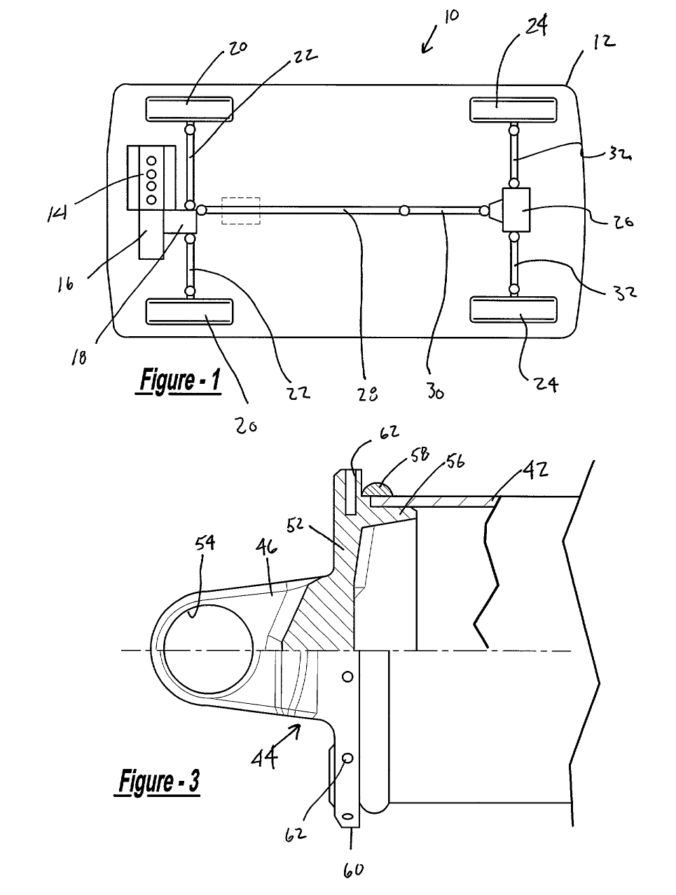

Turning to the figures, particularly FIG. 1, a driveline is illustrated and designated with the reference numeral 10. The driveline 10 is that of a four-wheel vehicle 12. The vehicle includes an engine 14 with a gear box 16 and a front axle differential 18. The front wheels 20 are driven via front driveshafts 22. The driving torque for the rear wheels 24 is branched off from the front axle differential 18 and transmitted to the rear axle differential 26 via a divided longitudinal driveshaft 28 and 30. Via the rear driveshafts 32, the rear axle differential 26 drives the rear wheels. The front and rear driveshafts, as well as the divided longitudinal driveshaft, may be designed in accordance with the invention.

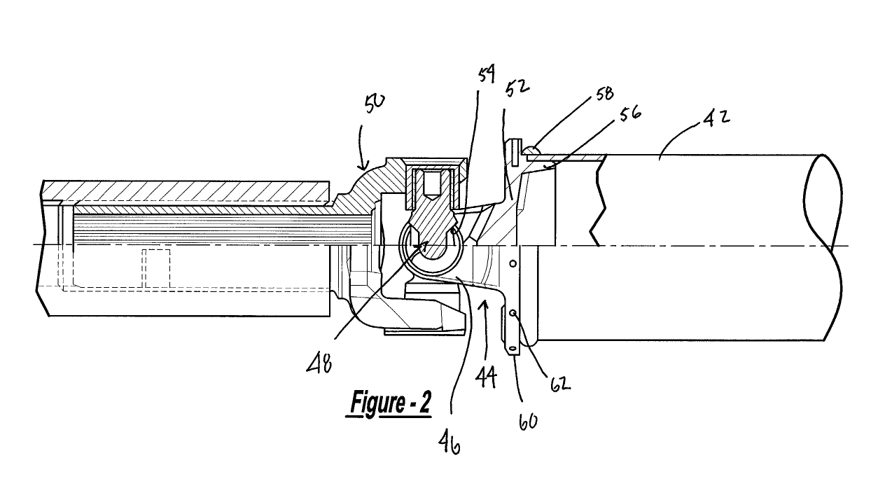

Turning to FIG. 2, a driveshaft is illustrated. The driveshaft includes a tubular portion 42 which has two ends. Each end includes a yoke 44 which is welded to the tube 42. Also, the yokes 44 include ears 46 which receive the universal joint 48. The universal joint 48 is coupled with a second yoke 50.

The tube 42 may be steel or aluminum. The tube 42 has a desired diameter as well as tube thickness. While the tube is manufactured within tight tolerances, discontinuities exist along the circumferential cross-section as well as along the longitudinal axis of the tube. The variations of the thickness of the tube is what causes rotational imbalances.

The yoke 44 includes a body 52. The ears 46 project from the body 52. The ears include cross-holes 54 which receive the bearing assembly of the universal joint 48. A skirt portion 56 projects from the other side of the body 52. The skirt portion 56 is inserted inside of the tube 42. The tube is then welded via weld 58 to the yoke 44.

The yoke body 52 includes a flange portion 60. The flange circumferentially surrounds the body 52. The flange 60 radially projects beyond the diameter of the tube 42. The flange 60, as shown, includes at least one bore 62. The bore 62 could be replaced by a ground portion or the bore could be a notched or cut portion. The removal of material from the flange 60 which forms the bore 62 is provided to balance the rotation of the driveshaft. By removing material from the flange 60, a rotational balance may be achieved in the driveshaft. Thus, the present invention eliminates the need for adding material to the driveshaft or yoke. Thus, the disadvantages which are present in adding material to the driveshaft are removed.

The driveshaft of the present invention is balanced as follows. A tubular member is provided. Yoke members are coupled or welded to the ends of the tubular element. The yoke members include flanges like those described. The driveshaft is rotated at a desired speed. As the driveshaft is rotated, vibrational imbalance can be determined. After the vibrational imbalance is determined, a position is indicated as to where and how much material is to be removed. The material is removed from the flange by cuffing, boring or grinding the material from the flange. After this occurs, the driveshaft is rotated again to determine that rotational balance has been achieved. If a rotational imbalance would exist, the above process would be repeated.

While the above detailed description describes the preferred embodiment of the present invention, the invention is susceptible to modification, variation and alteration without deviating from the scope and fair meaning of the subjoined claims.

What is claimed is:

1. A driveshaft comprising:
a tubular element having two ends;
at least one yoke coupled with one end of said tubular element, said at least one yoke including a stub shaft portion for coupling with said tubular element, a receiving portion for receiving a joint, and a balancing portion for balancing shaft rotation, said balancing portion including a desired mass of material, wherein said balancing portion enabling mass reduction so that mass may be removed from said balancing portion so that rotational imbalance of said driveshaft, during rotation, being eliminated.

2. The driveshaft according to claim 1, wherein a yoke is at each end of said shaft.

3. The driveshaft according to claim 1, wherein said balancing portion positioned between said stub shaft and said receiving portion.

4. The driveshaft according to claim 3, wherein said balancing portion being a circumferential flange.

5. The driveshaft according to claim 4, wherein said circumferential flange may be bored, ground, cut, or the like to remove material from said flange.

6. A method of balancing a driveshaft comprising:
providing a driveshaft having a tubular element with two ends and a yoke coupled at each end of said tubular element;
removing material from at least one of said yokes;
balancing rotational imbalance of said driveshaft through said removal of material from said at least one yoke.

7. The method according to claim 6, further comprising providing a flange on said yoke.

8. The method according to claim 7, further comprising removing material from said flange.

9. The method according to claim 8, further comprising boring, grinding, cutting or the like, said flange for removing said material.
